(19) United States
(12) Patent Application Publication
(10) Pub. No.: US 2025/0365546 A1
(43) Pub. Date: Nov. 27, 2025

(54) SYSTEM AND A METHOD FOR GENERATING A LOUDSPEAKER POSITION PROFILE FOR SOUND MANAGEMENT OF AN ACOUSTIC SYSTEM

(71) Applicant: HARMAN BECKER AUTOMOTIVE SYSTEMS GmbH, Karlsbad-Ittersbach (DE)

(72) Inventors: Christopher OATES, Bamberg (DE); Fanyu MENG, Oberschleissheim (DE); Adrian VON DEM KNESEBECK, Munich (DE); Friedrich VON TÜRCKHEIM, Hamburg (DE)

(21) Appl. No.: 19/179,367

(22) Filed: Apr. 15, 2025

(30) Foreign Application Priority Data
May 22, 2024 (EP) EP24177448.8

(51) Int. Cl. H04S 7/00; H04R 5/04

(52) U.S. Cl. CPC H04S 7/301; H04R 5/04; H04R 2205/024

(57) ABSTRACT

A computer-implemented method of generating a loudspeaker position profile for sound management of an acoustic system comprising a plurality of loudspeakers is provided. The method comprises receiving measurement data; determining types of loudspeakers; calculating angles of arrival; determining a spatial group for each loudspeaker; grouping loudspeakers into spatial groups; assigning each loudspeaker to a type group; grouping loudspeakers into type groups; generating the loudspeaker position profile; and providing the loudspeaker position profile to a sound field management system.

### CROSS-REFERENCE TO RELATED APPLICATIONS

This application claims priority benefit of Application No. EP24177448.8, titled “A SYSTEM AND A METHOD FOR GENERATING A LOUDSPEAKER POSITION PROFILE FOR SOUND MANAGEMENT OF AN ACOUSTIC SYSTEM,” and filed May 22, 2024. The subject matter of this related application is hereby incorporated by reference herein in its entirety.

### BACKGROUND

### Field of the Various Embodiments

The present application relates to a system and a method for generating a loudspeaker position profile for sound management of an acoustic system. The present application further relates to a use of the method for an acoustic system of a vehicle, a theatre, a conference room or alike multi-speaker sound system.

### Description of the Related Art

When tuning a multi-channel loudspeaker system to achieve the best possible stereo or 3D sound field reproduction, one must understand the arrangement of the loudspeakers and factor their location relative to the listening position into the sound field tuning. Failing to account for these sound system conditions will lead to audio artifacts such as poor localization of sounds and improper stereo/3D imaging. It is particularly problematic when the listening position is off-centre relative to the left and right stereo channels (or height channels for 3D reproductions). Many traditional loudspeaker layouts don't conform to the requirements of multi-channel audio standards and require spatial corrections to be applied based on the loudspeaker's true location. It is also problematic in cases when the loudspeaker drivers of a multi-way loudspeaker system are not co-located as in the automotive sound system case.

Moreover, it is common practice in the prior art to group sets of loudspeakers for simultaneous control during sound field tuning based on the loudspeaker's location and/or type. However, data acquisition for such grouping is not user friendly, time consuming and involves manual data logging. Additionally, many conventional sound field management systems don't consider the true position of the loudspeakers.

Furthermore, achieving a balanced (same for everyone) listening experience over many listening positions is very challenging since it requires too many parameters of an acoustic system to be controlled.

In view of the above, there is a need to automatically generate the loudspeaker location information (loudspeaker position profile, LPP) for sound field management systems. There is also a need to automatically group the loudspeakers by types and spatial location.

### SUMMARY

These needs are met by the features defined in the independent claims. The dependent claims define additional embodiments.

A computer-implemented method of generating a loudspeaker position profile, LPP, for sound management of an acoustic system comprising a plurality of loudspeakers is provided. The method comprises receiving measurement data of sound reproduced by each loudspeaker from the plurality of loudspeakers, wherein the sound is measured by one or more acoustic detectors placed at each target position of a plurality of target positions. The method further comprises determining a type of each loudspeaker from the measurement data. The method further comprises calculating from the measurement data an angle of arrival, AoA, for each loudspeaker at each target position. The method further comprises determining a spatial group for each loudspeaker from calculated one or more AoAs at one or more target positions. The method further comprises grouping the plurality of loudspeakers into spatial groups. The method further comprises assigning each loudspeaker to a type group according to determined type. The method further comprises grouping the plurality of loudspeakers into type groups. The method further comprises generating the LPP comprising a plurality of group identifiers and a plurality of loudspeaker identifiers linking each loudspeaker from the plurality of loudspeakers to determined spatial group and to assigned type group. The method further comprises providing the LPP via a computer interface to a sound field management system for use comprising controlling one or more parameters of sound output from the acoustic system based on the LPP.

According to some further aspects, use of the method of generating a loudspeaker position profile, LPP, for an acoustic system of a vehicle or an acoustic system of a theatre or a conference room is provided.

According to some further aspects, a computer system for generating a loudspeaker position profile, LPP, for sound management of an acoustic system is provided. The computer system comprises at least one computer processor configured to carry out method steps comprising: receiving measurement data of sound reproduced by each loudspeaker from the plurality of loudspeakers, wherein the sound is measured by one or more acoustic detectors placed at each target position of a plurality of target positions; determining a type of each loudspeaker from the measurement data; calculating from the measurement data an angle of arrival, AoA, for each loudspeaker at each target position; determining a spatial group for each loudspeaker from calculated one or more AoAs at one or more target positions; grouping the plurality of loudspeakers into spatial groups; assigning each loudspeaker to a type group according to determined type; grouping the plurality of loudspeakers into type groups; generating the LPP comprising a plurality of group identifiers and a plurality of loudspeaker identifiers linking each loudspeaker from the plurality of loudspeakers to determined spatial group and to assigned type group; and providing the LPP via a computer interface to a sound field management system for use comprising controlling one or more parameters of sound output from the acoustic system based on the LPP.

According to some further aspects, a computer program product is provided. The computer program product comprises computer readable instructions which, when executed by a computer processor, cause the computer processor to carry out method steps comprising: receiving measurement data of sound reproduced by each loudspeaker from the plurality of loudspeakers, wherein the sound is measured by one or more acoustic detectors placed at each target position of a plurality of target positions; determining a type of each loudspeaker from the measurement data; calculating from the measurement data an angle of arrival, AoA, for each loudspeaker at each target position; determining a spatial group for each loudspeaker from calculated one or more AoAs at one or more target positions; grouping the plurality of loudspeakers into spatial groups; assigning each loudspeaker to a type group according to determined type; grouping the plurality of loudspeakers into type groups; generating the LPP comprising a plurality of group identifiers and a plurality of loudspeaker identifiers linking each loudspeaker from the plurality of loudspeakers to determined spatial group and to assigned type group; and providing the LPP via a computer interface to a sound field management system for use comprising controlling one or more parameters of sound output from the acoustic system based on the LPP.

According to some further aspects, a storage medium storing a computer program product is provided. The computer program product comprises computer readable instructions which, when executed by a computer processor, cause the computer processor to carry out method steps comprising: receiving measurement data of sound reproduced by each loudspeaker from the plurality of loudspeakers, wherein the sound is measured by one or more acoustic detectors placed at each target position of a plurality of target positions; determining a type of each loudspeaker from the measurement data; calculating from the measurement data an angle of arrival, AoA, for each loudspeaker at each target position; determining a spatial group for each loudspeaker from calculated one or more AoAs at one or more target positions; grouping the plurality of loudspeakers into spatial groups; assigning each loudspeaker to a type group according to determined type; grouping the plurality of loudspeakers into type groups; generating the LPP comprising a plurality of group identifiers and a plurality of loudspeaker identifiers linking each loudspeaker from the plurality of loudspeakers to determined spatial group and to assigned type group; and providing the LPP via a computer interface to a sound field management system for use comprising controlling one or more parameters of sound output from the acoustic system based on the LPP.

The automatic generation of LPP can improve accuracy of loudspeakers location. For example, generating LPP automatically can detect true location of the loudspeakers that may be deviating from their intended locations.

A high level of position (location) accuracy may be required to effectively set the gain, delay, and frequency-dependent phase values to achieve a specific stereo image or, in other words, sound representation representing sound localisation or distribution associated with perception of a sound directly in from of the listener. Thus, the LPP may allow for more effectively setting one or more parameters of an acoustic system such as the gain, delay, and frequency-dependent phase values to achieve a specific stereo image (i.e., sound representation representing sound localisation or distribution associated with perception of a sound directly in front of the listener).

Additionally, LPP provides improved data structure (metadata) that allows for better usability of data related to location and type of loudspeakers. LPP data structure can provide loudspeaker grouping in a multi-way (non-co-located case) and also for a “regional” case, e.g., when all the front loudspeakers can be grouped, or all the rear loudspeakers can be grouped by loudspeakers type. Such grouping allows for controlling all loudspeakers simultaneously for adjusting parameters of an acoustic system, for example, turning up the bass by controlling all the loudspeakers from a group of loudspeakers belonging to a woofer type.

The LPP data structure may be searchable data structure that can be stored as a metadata. By using the LPP data structure, sound field management systems can control acoustic systems more efficiently by, for example, automatically adjusting parameters of the acoustic system to offset for the true location of the loudspeakers in case the true location deviates from an intended location.

Automatic generation of the LPP data structure (or simply referred to as LPP) allows for achieving a balanced (same for everyone) listening experience over many listening positions since many parameters of an acoustic system can be determined automatically, grouped, and controlled simultaneously that was not possible before with manual methods. Thus, LPP provides for optimization and automation of the sound field control beyond what a human could achieve with manual methods.

The features set out above and those described below may be used not only in the corresponding combinations explicitly set out, but also in other combinations or in isolation, without departing from the scope of protection of the present disclosure.

### BRIEF DESCRIPTION OF THE DRAWINGS

The present disclosure will now be described more fully hereinafter with reference to the accompanying drawings, in which embodiments of the disclosure are shown. However, this disclosure should not be construed being limited to the embodiments set forth herein. Rather, these embodiments are provided so that this disclosure will be thorough and complete, and will fully convey the scope of the disclosure to those skilled in the art. Like numbers refer to like elements throughout.

FIG. 1a schematically shows a computer system 100a for an acoustic system 102 according to one of a number of embodiments.

FIG. 1b schematically shows a data acquisition system 100b according to one of a number of embodiments.

FIG. 2a schematically shows an acoustic system 200a of a theatre or alike multi-speaker sound system according to one of a number of embodiments.

FIG. 2b schematically shows an acoustic system 200b of a theatre or alike multi-speaker sound system according to one of a number of embodiments.

FIG. 2c schematically shows an acoustic system 200c of a vehicle according to one of a number of embodiments.

FIG. 2d schematically shows an acoustic system 200d of a vehicle according to one of a number of embodiments.

FIG. 2e schematically shows an acoustic system 200e of a vehicle according to one of a number of embodiments.

FIG. 3 schematically shows identification of angles of arrival 300 according to one of a number of embodiments.

FIG. 4 schematically shows a method 400 of generating a loudspeaker position profile for sound management of an acoustic system according to one of a number of embodiments.

### DETAILED DESCRIPTION

The properties, features and advantages described above and the way in which they are achieved will become clearer and more clearly understood in association with the following description of the exemplary embodiments which are explained in greater detail in connection with the drawings. For simplicity and illustrative purposes, the present disclosure is described by referring mainly to an exemplary embodiment thereof. In the following description, numerous specific details are set forth in order to provide a thorough understanding of the present disclosure. However, it will be readily apparent to one of ordinary skill in the art that the present disclosure may be practiced without limitation to these specific details. In this description, well-known methods and structures have not been described in detail so as not to unnecessarily obscure the present disclosure.

Some examples of the present disclosure generally provide for a plurality of circuits or other electrical devices. All references to the circuits and other electrical devices and the functionality provided by each are not intended to be limited to encompassing only what is illustrated and described herein. While particular labels may be assigned to the various circuits or other electrical devices disclosed, such labels are not intended to limit the scope of operation for the circuits and the other electrical devices. Such circuits and other electrical or electronic devices may be combined with each other and/or separated in any manner based on the particular type of electrical implementation that is desired. It is recognized that any circuit or other electrical or electronic device (e.g., an acoustic system, a computer system) disclosed herein may include any number of microcontrollers, a graphics processor unit (GPU), integrated circuits, memory devices and software which co-act with one another to perform operation(s) disclosed herein. In addition, any one or more of the electrical or electronic devices may be configured to execute a program code (for an acoustic system) that is embodied in a non-transitory computer readable medium programmed to perform any number of the functions as disclosed.

In the following, embodiments of the disclosure will be described in detail with reference to the accompanying drawings. It is to be understood that the following description of embodiments is not to be taken in a limiting sense. The scope of the disclosure is not intended to be limited by the embodiments described hereinafter or by the drawings, which are taken to be illustrative only.

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

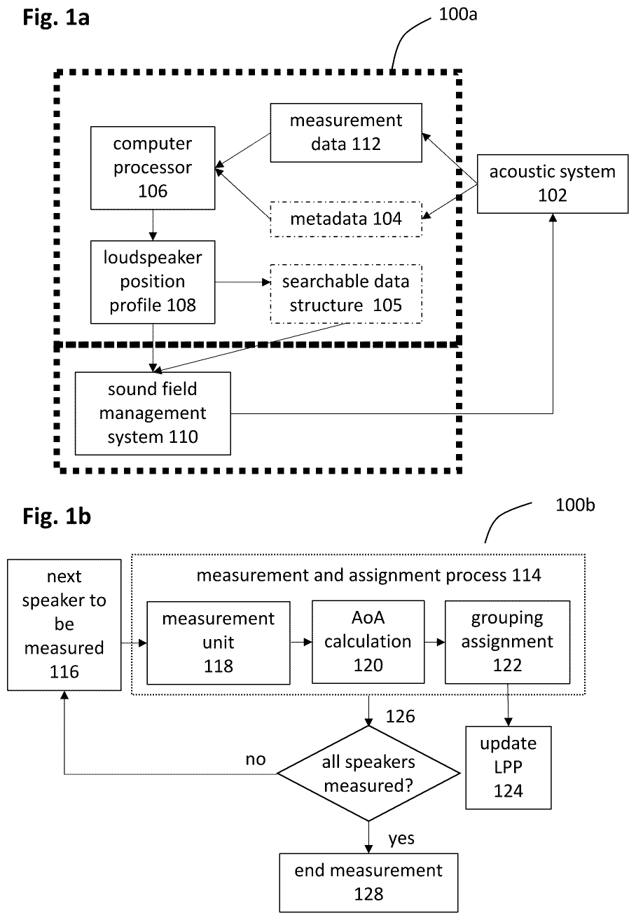

FIG. 1a schematically shows a computer system 100a for an acoustic system 102 according to one of a number of embodiments.

The computer system 100a for generating a loudspeaker position profile, LPP 108, for sound management of an acoustic system comprises at least one computer processor 106 configured to carry out method steps further described in the context of FIG. 4 (i.e., receiving measurement data of sound reproduced by each loudspeaker from the plurality of loudspeakers, wherein the sound is measured by one or more acoustic detectors placed at each target position of a plurality of target positions; determining a type of each loudspeaker from the measurement data; calculating from the measurement data an angle of arrival, AoA, for each loudspeaker at each target position; determining a spatial group for each loudspeaker from calculated one or more AoAs at one or more target positions; grouping the plurality of loudspeakers into spatial groups; assigning each loudspeaker to a type group according to determined type; grouping the plurality of loudspeakers into type groups; generating the LPP comprising a plurality of group identifiers and a plurality of loudspeaker identifiers linking each loudspeaker from the plurality of loudspeakers to determined spatial group and to assigned type group; and providing the LPP via a computer interface to a sound field management system for use comprising controlling one or more parameters of sound output from the acoustic system based on the LPP).

Measurement data 112 for generating LPP 108 may be acquired by a data acquisition system 100b further described in the context of FIG. 1b.

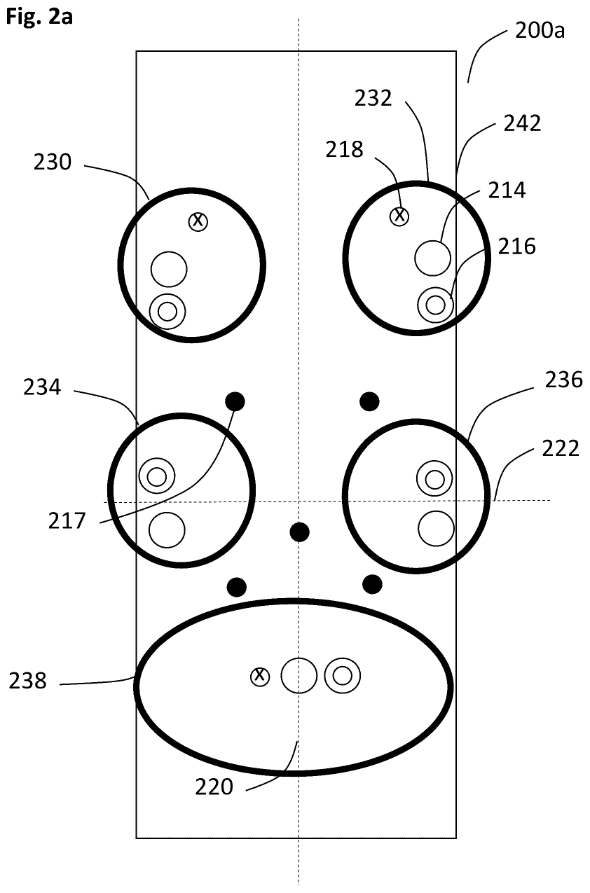

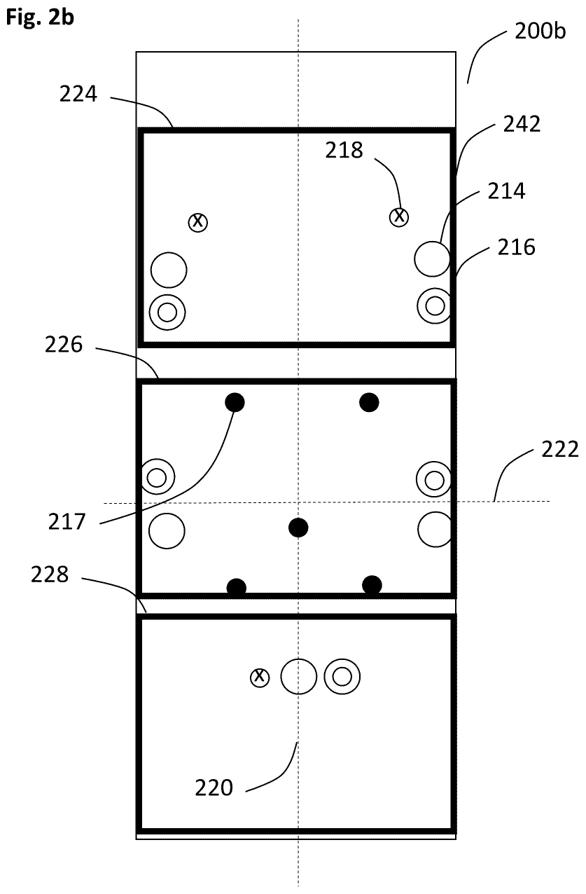

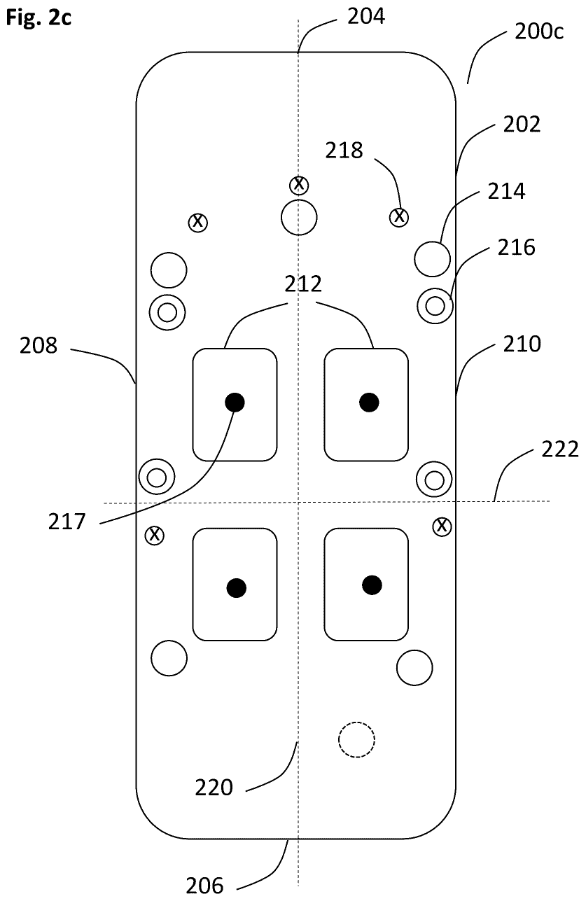

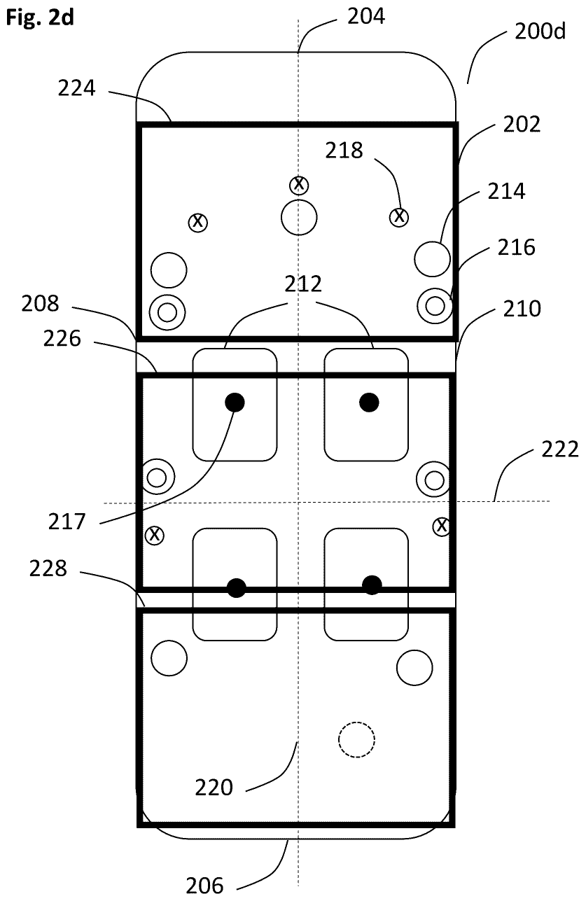

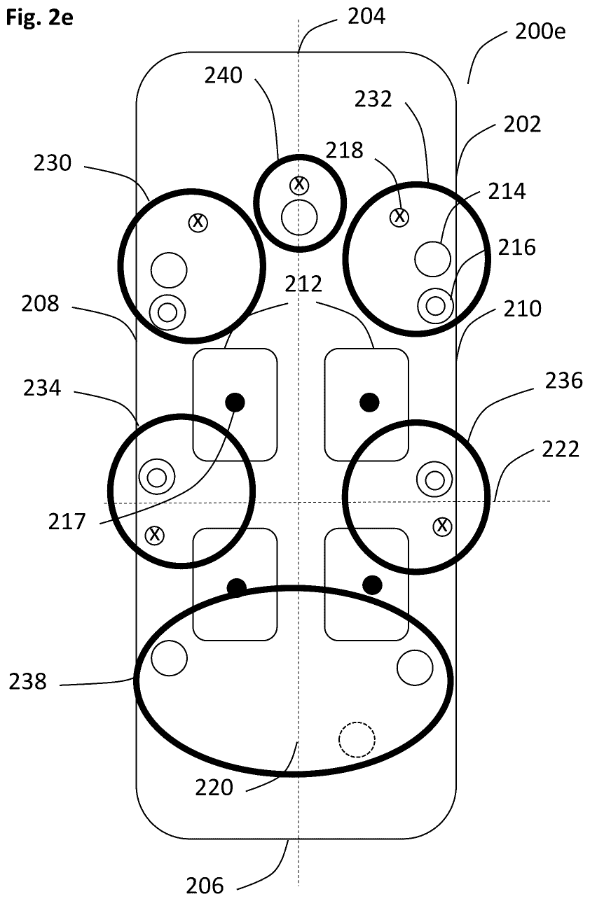

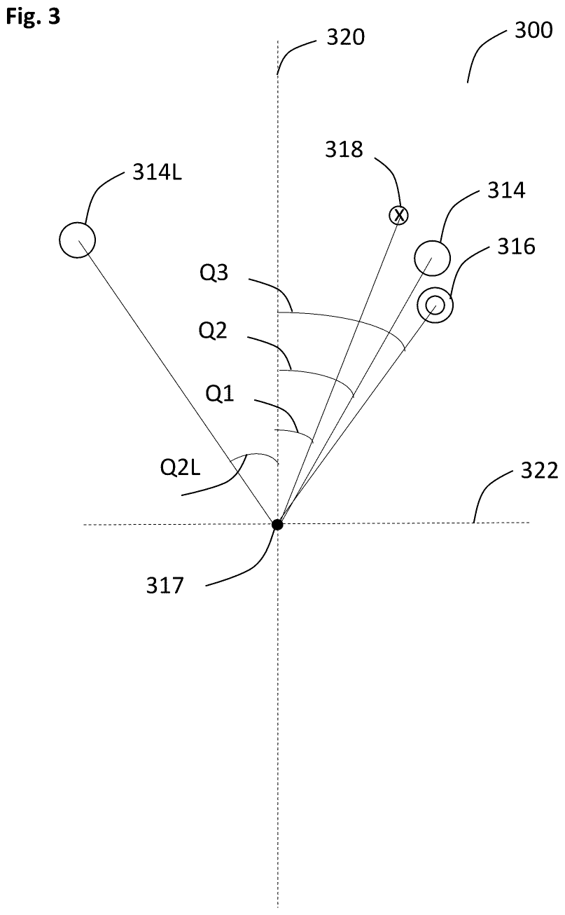

Measurement data 112 may comprise a sound reproduced by each loudspeaker from a plurality of loudspeakers of an acoustic system 102. The sound is measured by one or more acoustic detectors placed at each target position of a plurality of target positions. The one or more acoustic detectors may be one or more measurement units 118 comprising one or more microphones 217 as further described in the context of FIGS. 1b and 2a-2d.

Measurement data 112 may be provided to a computer processor 106 for generating LPP 108.

From the measurement data 112, a type of each loudspeaker may be determined. Also from the measurement data 112, an angle of arrival, AoA, for each loudspeaker at each target position may be calculated based on which a spatial group for each loudspeaker may be determined. Then, the plurality of loudspeakers can be grouped into spatial groups. Each loudspeaker from the plurality of loudspeakers may be assigned to a type group according to determined type. The plurality of loudspeakers may be grouped into type groups according to the assigned type.

Measurement data 112 may be provided to a computer processor 106 or received by the computer processor 106 via a computer interface via any kind of data transfer, e.g., uploading or downloading data, receiving access to data on a server or a cloud, accessing data on a server or a cloud, receiving data on an electronic storage medium, wireless data transfer or alike data transfer.

Similar to receiving by or providing measurement data 112 to computer processor 106, LPP 108 may be provided to sound field management system 110 via a computer interface via any kind of data transfer.

LPP 108 comprises a plurality of group identifiers and a plurality of loudspeaker identifiers linking each loudspeaker from the plurality of loudspeakers to determined spatial group and to assigned type group.

Generated LPP 108 is provided via a computer interface to a sound field management system 110 for use comprising controlling one or more parameters of sound output from an acoustic system 102.

Acoustic system 102 may have a configuration as illustrated in FIGS. 2a-2d for acoustic systems 200a; 200b; 200c; 200d.

According to various examples, generating LPP 108 may further comprise determining a total number of loudspeakers in the plurality of loudspeakers from the measurement data 112, wherein determining the total number of loudspeakers comprises determining a number of audio files comprised in the measurement data 112 or determining a number of sound channels used for obtaining the measurement data 112.

According to various examples, determining the type of each loudspeaker may comprise matching frequency spectra comprised in the measurement data 112 to reference spectra associated with a plurality of loudspeaker types. Reference spectra, similar as measurement data 112, may be provided to computer processor 106 via a computer interface.

According to various examples, determining the spatial group for each loudspeaker may comprise applying a division algorithm to the number of loudspeakers for generating a plurality of possible divisions of the plurality of loudspeakers into spatial groups. For example, for an acoustic system comprising 14 loudspeakers there may be a plurality of three possible divisions into 3, 5 or 6 spatial groups as further illustrated by FIGS. 2a-2d. Possible divisions into type groups may be equal to the number of types of loudspeakers (e.g., one division into 3 type groups: woofer, tweeter, mid-rage type group, as further illustrated by FIGS. 2a-2d). The division algorithm may incorporate adjustable criteria for determining a number of possible divisions. The adjustable criteria may comprise one or more numbers of axes of symmetry. The division algorithm may further incorporate selecting at least one division from the plurality of possible divisions based on predefined selection criteria, wherein the predefined selection criteria may comprise user input and/or a likelihood for each division from the plurality of possible divisions. For example, for one axis of symmetry, front-to-rear, division into 3 spatial groups may be more likely as to 5 or 6. For two axes of symmetry, front-to-rear and side-to-side, division into 5 or 6 spatial groups may be more likely as into 3 groups. In another example, grouping into 3 spatial groups may be more frequently occurring and thus may have a higher likelihood as to 5 or 6 groups. In an example, a user may be provided with a choice of divisions. The at least one division may further comprise the number of spatial groups and location information associated with each spatial group. Determining the spatial group may further comprise automatically assigning each loudspeaker to a spatial group from the number of spatial groups based on calculated AoAs being indicative of spatial location of each loudspeaker.

According to various examples, the computer-implemented method (or simply referred to as “method”) of generating LPP 108 may further comprise receiving metadata 104 for aiding loudspeakers grouping into the spatial groups and/or the type groups. The metadata 104 may indicate a number of spatial groups wherein the number of spatial groups facilitates a selection of spatial grouping from multiple candidates of spatial grouping, location information associated with each spatial group further facilitating the selection of spatial grouping from multiple candidates of spatial grouping, and/or types of loudspeakers facilitating assignment of loudspeakers into type groups.

In addition to measurement data 112, metadata 104 may be provided to a computer processor 106 for assisting with generating LPP 108. Metadata 104 may be associated with the acoustic system 102; 200a; 200b; 200c; 200d; 200e. For example, metadata 104 may comprise a total number and a type identifier(s) of a plurality of loudspeakers comprised in the acoustic system 102, 200a; 200b; 200c; 200d; 200e that may aid in grouping of loudspeakers from the plurality of loudspeakers into spatial and type groups.

Similar to receiving by or providing measurement data 112 to computer processor 106, metadata 104 may be provided to computer processor 106 via a computer interface via any kind of data transfer.

According to various examples, the method of generating LPP 108 may further comprise generating a searchable data structure 105. The searchable data structure 105 may comprise the LPP. The method of generating LPP 108 may further comprise saving the searchable data structure 105 in an electronic database and/or a cloud for the use by the sound field management system 110 comprising searching spatial groups and/or type groups automatically for simultaneous control of one or more parameters of loudspeakers belonging to one group.

The searchable data structure 105 comprising the LPP may be referred to as metadata since it also (as metadata 104) provides information about the acoustic system 102.

The searchable data structure 105 comprising the LPP provides a structured (comprising identifiers), classified (by groups), searchable (by identifiers) data form allowing for searching spatial groups and/or type groups automatically and controlling of one or more parameters of loudspeakers belonging to one group simultaneously.

The searchable data structure 105 may be stored on an electronic storage medium, similar as metadata 104.

According to various examples, controlling of one or more parameters of loudspeakers may comprise simultaneous control of loudspeakers belonging to the same type group and/or the same spatial group.

According to various examples, the simultaneous control may comprise controlling one or more parameters of sound output from acoustic system 102 comprising any one of amplitude, delay time, frequency spectrum and/or phase.

According to various examples, the simultaneous control of one or more parameters of sound output from acoustic system 102 may comprise a relative control of the one or more parameters between at least two groups.

According to various examples, the simultaneous control of one or more parameters of sound output from acoustic system 102 may comprise maintaining a relative relationship between the one or more parameters of the at least two groups when one or more conditions associated with the at least two groups change. The one or more conditions may comprise one or more locations of one or more loudspeakers from the plurality of loudspeakers. A change in the one or more conditions may be identified automatically by determining one or more AoAs associated with the one or more loudspeakers for a new condition and for a previous condition, and by comparing the one or more AoAs for the new condition and for the previous condition.

According to various examples, the use of the LPP 108 by the sound filed management system 110 may further comprise generating a sound representation representing sound localization, including one or more binaural cues. The one or more binaural cues may comprise an interaural time difference, ITD, an interaural level difference, ILD, and/or an interaural phase difference, IPD. Based on the sound representation, one or more parameters of sound output from the plurality of loudspeakers may be adjusted until the one or more binaural cues are equalized resulting in the sound representation comprising identical sound representation received by the left and right ear of a listener placed at a target position. According to various examples, the one or more parameters may comprise any one of sound amplitude, delay time, frequency spectrum and/or phase.

According to various examples, the method of generating LPP 108 may further comprise detecting a change in one or more AoAs associated with one or more loudspeakers from the plurality of loudspeakers and automatically compensating for the change by adjusting one or more parameters of sound output from the plurality of loudspeakers such that sound distribution representing sound localization becomes symmetrical with respect to a target position where a listener and/or a microphone is to be placed.

According to various examples, the one or more parameters of sound output from acoustic system 102 may comprise any one of sound amplitude, delay time, frequency spectrum and/or phase.

FIG. 1b schematically shows a data acquisition system 100b according to one of a number of embodiments.

Data acquisition system 100b may be used to acquire measurement data 112 described in the context of FIG. 1a.

Measurement data 112 may comprise, e.g., amplitude, frequency spectra of an acoustic sound measured by one or more detectors (microphones) at one or more target positions located in a room or a measurement space as, for example, illustrated by FIGS. 2a-2d.

The acoustic sound may be produced by a plurality of loudspeakers (or simply referred to as “speakers”) one by one in a sequence for measuring acoustic sound produced by one loudspeaker at a time.

At 116, the acoustic sound produced by each loudspeaker from the plurality of loudspeakers may be measured at each target position by a detector (microphone) until acoustic sound from all loudspeakers is measured.

At 126, it is identified if all loudspeakers are measured.

At 128, when all loudspeakers are measured, the measurement process ends.

The measurement and assignment process 114 continues until all speakers are measured and ends after that, at 128.

Acoustic sound produced by each loudspeaker may be measured by a measurement unit 118 comprising at least one microphone 217, as further illustrated in FIGS. 2a-2d.

At 120, an angle of arrival, AoA, for each speaker at each target position, where a measurement unit 118 is placed, may be calculated based on the direction of acoustic energy generated by each loudspeaker and received by measurement unit 118 placed at a target position.

At grouping assignment 122, from the measured acoustic sound comprising frequency and amplitude spectra and from the calculated AoAs, the loudspeakers may be grouped into type and spatial groups.

After the grouping assignment 122, LPP 108 may be generated comprising a group identifier and a loudspeaker identifier linking a loudspeaker from the plurality of loudspeakers to a spatial group and to a type group.

At 124, LPP 108 may be updated after each loudspeaker is measured at 116, until all loudspeakers are measured at 128. After the last loudspeaker is measured, LPP 108 may be updated to comprise a plurality of group identifiers and a plurality of loudspeaker identifiers linking each loudspeaker from the plurality of loudspeakers to determined spatial group and to assigned type group.

FIG. 2a schematically shows an acoustic system 200a of a theatre or alike multi-speaker sound system according to one of a number of embodiments.

Method 400 described in the context of FIG. 4 may be used for the acoustic system 200a of a theatre, a conference room or alike multi-speaker sound system.

A plurality of loudspeakers of the acoustic system 200a illustrated in FIG. 2a comprises a mid-range loudspeakers 214; woofer loudspeakers 216; and tweeter loudspeakers 218. In FIG. 2a, five microphones 217 are placed at five target positions (seats) where a listener is to be located. The loudspeakers may be grouped along a longitudinal axis 220 into front to rear groups and along a transverse axis 222 into side groups. The number of seats for listeners and loudspeakers in FIG. 2a are not limiting. The method and the system of the current disclosure is applicable to any number or type of loudspeakers and/or seats (target positions for microphones/listeners) in a theatre or a conference room or alike multi-speaker sound system.

The loudspeakers in FIG. 2a are grouped into a front-left spatial group 230; a front-right spatial group 232; a side-left spatial group 234; a side-right spatial group 236 and a rear-centre spatial group 238. Alternatively, the loudspeakers may be grouped into a front spatial group 224; a side spatial group 226; and a rear spatial group 228, as further described in the context of FIG. 2b.

Thus, the spatial groups may comprise a front-left spatial group 230, a front-right spatial group 232, a side-left spatial group 234, a side-right spatial group 236 and a rear-centre spatial group 238 wherein the front and rear is determined along a longitudinal axis 220 and wherein the left and right is determined along a transverse axis 222. The spatial groups may further comprise one or more height groups determined along a vertical axis (not shown in FIG. 2a). The vertical axis may extend across measurement space in parallel to a direction of gravity force and the longitudinal 220 and the transverse 222 axes are perpendicular to each other and to the vertical axis.

As illustrated in FIG. 2a, the type groups may comprise any one of a tweeter, a mid-range and/or a woofer type groups.

A tweeter type group may comprise one or more tweeter loudspeakers 218.

A mid-range type group may comprise one or more a mid-range loudspeakers 214.

A woofer type group may comprise one or more woofer loudspeakers 216.

Each spatial group (a front-left spatial group 230, a front-right spatial group 232, a side-left spatial group 234, a side-right spatial group 236 and a rear-centre spatial group 238) may comprise one or more tweeter loudspeakers 218, one or more mid-range loudspeakers 214, and/or one or more woofer loudspeakers 216.

The measurement space may be a room or a region 242 where an acoustic system 200a is to be located.

The measurement of sound reproduced by each of mid-range loudspeakers 214, woofer loudspeakers 216, tweeter loudspeakers 218 may be measured by one or more microphones 217.

A transverse axis 222 may be perpendicular to the longitudinal axis 220.

Front to rear direction of the measurement space may extend along longitudinal axis 220 for front-to-rear grouping.

Side to side direction of the measurement space may extend along transverse axis 222 for side-to-side grouping.

Up and down direction of the measurement space may extend along the vertical axis for height-wise grouping (not shown in FIG. 2a).

A room or a region 242 defining the measurement space may be a room for a home theatre, a room for a commercial theatre, a conference room, and/or alike where acoustic system 200a is to be located.

A target position where a microphone 217 and/or a listener is to be placed may be a centre of a seat for a listener at a conference room or a theatre (along longitudinal axis 220 and transverse axis 222). Optionally, there may be one or more target positions where a microphone 217 is to be placed along the vertical axis. One target position along the vertical axis may be located at a height, for example, where a head of a listener is to be placed (e.g., from 50 cm to 90 cm from a seat cushion in the direction opposite to gravity force).

FIG. 2b schematically shows an acoustic system 200b of a theatre or alike multi-speaker sound system according to one of a number of embodiments.

Method 400 described in the context of FIG. 4 may be used for the acoustic system 200b of a theatre, a conference room or alike multi-speaker sound system.

A plurality of loudspeakers of the acoustic system 200b illustrated in FIG. 2b comprises mid-range loudspeakers 214; woofer loudspeakers 216; and tweeter loudspeakers 218. In FIG. 2b, five microphones 217 are placed at five target positions (seats) where a listener is to be located. The loudspeakers may be grouped along a longitudinal axis 220 into front to rear groups and along a transverse axis 222 into side groups. A target position may be a centre of a seat. The number of seats/microphones or loudspeakers in FIG. 2b are not limiting for the method and the system of the current disclosure.

The loudspeakers in FIG. 2b are grouped into a front spatial group 224; a side spatial group 226; a rear spatial group 228.

Each spatial group (a front spatial group 224; a side spatial group 226; and a rear spatial group 228) may comprise one or more tweeter loudspeakers 218, one or more mid-range loudspeakers 214, and/or one or more woofer loudspeakers 216.

As illustrated in FIG. 2b, the type groups may comprise any one of a tweeter, a mid-A tweeter type group may comprise one or more tweeter loudspeakers 218.

A mid-range type group may comprise one or more a mid-range loudspeakers 214.

A woofer type group may comprise one or more woofer loudspeakers 216.

As illustrated in FIG. 2b, the spatial groups may comprise a front spatial group 224, a side spatial group 226 and a rear spatial group 228 determined along a longitudinal axis 220. The side spatial group 226 may be located between the front spatial group 224 and the rear spatial group 228. The spatial groups may further comprise one or more height groups determined along a vertical axis (not shown in FIG. 2b). The vertical axis may extend across measurement space in parallel to a direction of gravity force. The longitudinal axis 220 may extend across the measurement space perpendicular to the gravity force.

According to various examples, determining the spatial group for each loudspeaker may comprise applying a division algorithm to the number of loudspeakers for generating a plurality of possible divisions of the plurality of loudspeakers into spatial groups. For example, determining the spatial groups, as illustrated in FIG. 2a or 2b, may comprise applying the division algorithm. For example, the division algorithm may incorporate adjustable criteria for determining a number of possible divisions, e.g., division into three groups in FIG. 2b and five groups in FIG. 2a. The adjustable criteria may comprise one or more numbers of axes of symmetry. The division algorithm may further incorporate selecting at least one division (e.g., three or five) from the plurality of possible divisions based on predefined selection criteria, wherein the predefined selection criteria may comprise user input and/or a likelihood for each division from the plurality of possible divisions. For example, grouping into the three groups as illustrated in FIG. 2b may be more frequent (more likely) than into five groups as illustrated in FIG. 2a, or other way round. The selection criteria may be provided to computer processor 106. The at least one division (e.g., three in FIG. 2b) may comprise the number of spatial groups (i.e., three) and location information (LPP) associated with each spatial group. Determining the spatial group may further comprise automatically assigning each loudspeaker to a spatial group (a front spatial group 224, a side spatial group 226 and a rear spatial group 228) from the number of spatial groups based on calculated AoAs being indicative of spatial location of each loudspeaker.

According to various examples, the computer-implemented method of generating LPP 108 may further comprise receiving metadata 104 for aiding loudspeakers grouping into the spatial groups and/or the type groups. For example, the loudspeakers may be divided into five groups as illustrated in FIG. 2a or three groups as illustrated in FIG. 2b resulting in two candidates for spatial grouping. The metadata 104 may indicate a number of spatial groups (e.g., five) wherein the number of spatial groups facilitates a selection of spatial grouping from multiple candidates of spatial grouping. The metadata 104 may indicate location information associated with each spatial group further facilitating the selection of spatial grouping from multiple candidates of spatial grouping, and/or types of loudspeakers facilitating assignment of loudspeakers into type groups. For example, metadata 104 may indicate that six loudspeakers should be located in a front spatial group aiding spatial grouping.

The location of the loudspeakers and microphones in the acoustic systems, as for example, illustrated in FIGS. 2a and 2b may be similar (i.e., 14 loudspeakers of three types and five target positions for a microphone 217), but the grouping and group control of the loudspeakers may be different (i.e., five spatial groups in FIG. 2a and three spatial groups in FIG. 2b).

A room or a region 242 for a multi-speaker sound system may define the measurement space.

FIG. 2c schematically shows an acoustic system 200c of a vehicle according to one of a number of embodiments.

Method 400 described in the context of FIG. 4 may be used for an acoustic system 200c of a vehicle.

The measurement space in FIG. 2c relates to the interior space of a cabin of a vehicle 202.

The measurement space may be defined by a vehicle front 204; a vehicle rear 206; a vehicle left side 208 and a vehicle left side 210. Target positions for placing a microphone may correspond to the positions of vehicle seats 212. For example, a target position where a microphone 217 and/or a listener is to be placed may be a central position of a vehicle seat 212 along longitudinal axis 220 and transverse axis 222.

A plurality of loudspeakers of the acoustic system 200c illustrated in FIG. 2c comprises a mid-range loudspeakers 214; woofer loudspeakers 216; and tweeter loudspeakers 218. In FIG. 2c, four microphones 217 are placed at four target positions (seats) where a listener is to be located. The loudspeakers may be grouped along a longitudinal axis 220 into front to rear groups and along a transverse axis 222 into side groups.

The loudspeakers may be grouped into a front spatial group 224; a side spatial group 226; a rear spatial group 228 as further described in the context of FIG. 2d. Alternatively, the loudspeakers may be grouped into a front-left spatial group 230; a front-right spatial group 232; a side-left spatial group 234; a side-right spatial group 236; a rear-centre spatial group 238; and a front-centre spatial group 240, as further described in the context of FIG. 2e.

FIG. 2d schematically shows an acoustic system 200d of a vehicle according to one of a number of embodiments.

Method 400 described in the context of FIG. 4 may be used for an acoustic system 200d of a vehicle.

The loudspeakers in FIG. 2d are grouped into a front spatial group 224; a side spatial group 226; a rear spatial group 228. The spatial groups (front spatial group 224; side spatial group 226; rear spatial group 228) may further comprise one or more height groups determined along a vertical axis (not shown in FIG. 2d). The vertical axis may extend across measurement space in parallel to a direction of gravity force. The longitudinal axis 220 may extend across the measurement space perpendicular to the gravity force.

Each spatial group (a front spatial group 224; a side spatial group 226; and a rear spatial group 228) may comprise one or more tweeter loudspeakers 218, one or more mid-range loudspeakers 214, and/or one or more woofer loudspeakers 216.

As illustrated in FIG. 2d, the type groups may comprise any one of a tweeter, a mid-A tweeter type group may comprise one or more tweeter loudspeakers 218.

A mid-range type group may comprise one or more a mid-range loudspeakers 214.

A woofer type group may comprise one or more woofer loudspeakers 216.

FIG. 2e schematically shows an acoustic system 200e of a vehicle according to one of a number of embodiments.

Method 400 described in the context of FIG. 4 may be used for an acoustic system 200e of a vehicle.

The loudspeakers in FIG. 2e are grouped into a front-left spatial group 230; a front-right spatial group 232; a side-left spatial group 234; a side-right spatial group 236; a rear-centre spatial group 238; and a front-centre spatial group 240.

The spatial groups (front-left spatial group 230; front-right spatial group 232; side-left spatial group 234; side-right spatial group 236; rear-centre spatial group 238; and front-centre spatial group 240) may further comprise one or more height spatial groups determined along a vertical axis (not shown in FIG. 2e). The vertical axis may extend across measurement space in parallel to a direction of gravity force. The longitudinal axis 220 may extend across the measurement space perpendicular to the gravity force.

As illustrated in FIG. 2e, the type groups may comprise any one of a tweeter, a mid-range and/or a woofer type groups.

A tweeter type group may comprise one or more tweeter loudspeakers 218.

A mid-range type group may comprise one or more a mid-range loudspeakers 214.

A woofer type group may comprise one or more woofer loudspeakers 216.

Each spatial group (front-left spatial group 230; front-right spatial group 232; side-left spatial group 234; side-right spatial group 236; rear-centre spatial group 238; and front-centre spatial group 240) may comprise one or more tweeter loudspeakers 218, one or more mid-range loudspeakers 214, and/or one or more woofer loudspeakers 216.

The location of the loudspeakers and microphones 217 in the acoustic systems, as for example, illustrated in FIGS. 2d and 2e, may be similar (i.e., 14 loudspeakers of three types and four target positions for a microphone 217), but the grouping and group control of the loudspeakers may be different (i.e., three spatial groups in FIG. 2d and six spatial groups in FIG. 2e).

Thus, as illustrated in FIGS. 2a-2e, the loudspeakers may be grouped into one or more type groups, e.g., tree type groups: a mid-range loudspeaker 214 type group; a woofer loudspeaker 216 type group and a tweeter loudspeaker 218 type group. As also illustrated in FIG. 2a-2e, the loudspeakers may be grouped into one or more spatial groups, e.g., three in FIGS. 2b and 2d, five in FIG. 2a and six in FIG. 2d. Said grouping (both, spatial and by type) allows for one or more parameters, e.g., frequency, amplitude of sound, to be controlled simultaneously for all loudspeakers in a group.

As illustrated by FIGS. 2a-2d, the one or more microphones 217 may be placed at one or more target positions located in a room or a measurement space. For example, a target position may be a seat for a listener at a theatre or a conference room or a vehicle seat. A target position may be a center of the seat (e.g., along a longitudinal axis 220 and a transverse axis 222, where the axes may be perpendicular to each other). Optionally, there may be one or more target positions along a vertical axis (not shown in FIGS. 2a-2d), that may be perpendicular to the longitudinal axis 220 and the transverse axis 222 in FIGS. 2a-2d, for grouping the loudspeakers into height groups.

According to various examples, the simultaneous control may comprise controlling one or more parameters of sound output from any one of acoustic systems illustrated in FIGS. 2a-2d comprising any one of amplitude, delay time, frequency spectrum and/or phase.

According to various examples, the simultaneous control comprises a relative control of the one or more parameters between at least two groups (e.g., front spatial group 224 and rear spatial group 228 in FIGS. 2b and 2d); or maintaining a relative relationship between the one or more parameters of the at least two groups when one or more conditions associated with the at least two groups change. The one or more conditions may comprise one or more locations of one or more loudspeakers from the plurality of loudspeakers. A change in the one or more conditions may be identified automatically by determining one or more AoAs associated with the one or more loudspeakers for a new condition and for a previous condition, and by comparing the one or more AoAs for the new condition and for the previous condition.

For example, simultaneous control may comprise maintaining a relative relationship between a front spatial group 224 and rear spatial group 228 in FIGS. 2b and 2d if something else changes (e.g., a location of a loudspeaker in a group). For example, when a sound is to be perceived to come mostly from the front, a relative gain and delay relationship may be implemented, e.g., front spatial group 224 loudspeakers may be 3 dB louder and the rear spatial group 228 loudspeakers may be 2 milliseconds delayed relative to the front spatial group 224 loudspeakers.

According to various examples, the use of LPP 108 may further comprise generating a sound representation representing sound localization, including one or more binaural cues. The one or more binaural cues may comprise an interaural time difference, ITD, an interaural level difference, ILD, and/or an interaural phase difference, IPD. Based on the sound representation, one or more parameters of sound output from the plurality of loudspeakers may be adjusted until the one or more binaural cues are equalized resulting in the sound representation comprising identical sound representation received by the left and right ear of a listener placed at a target position. The one or more parameters may comprise any one of sound amplitude, delay time, frequency spectrum and/or phase.

According to various examples, a sound representation may be a phantom sound source. The phantom sound source may be referred to as a virtual sound source created by two identical loudspeakers driven with the same signals. For example, if two identical loudspeakers (e.g., a mid-range loudspeaker 214 of front-left spatial group 230 and a mid-range loudspeaker 214 of front-right spatial group 232 in FIG. 2a) are driven with the same signals in terms of frequency, level and phase, then the listener (e.g., placed at a target position on the longitudinal axis 220 where a microphone 217 is to be located) may locate both sound sources as one sound source centred between the two sound sources. This localized virtual sound source or representation of sound may be referred to as a phantom sound source. The prerequisite for centred sound source is that the loudspeakers are driven with identical signals and that there are also the same propagation times between the loudspeakers and the listener. Even the smallest deviations (e.g., 1 ms) no longer cause a phantom effect (centred sound). The listener then hears the sound source with the shorter propagation time. With even smaller runtime differences, the listener already perceives volume differences in which case centring of sound representation may be required.

According to various examples, centering of the sound representation may be implemented by simultaneously controlling one or more parameters of each loudspeaker of one or more type groups (e.g., mid-range loudspeaker 214 type group; woofer loudspeaker 216 type group and tweeter loudspeaker 218 type group) and/or one or more spatial groups (e.g., front spatial group 224; side spatial group 226; rear spatial group 228; front-left spatial group 230; front-right spatial group 232: a side-left spatial group 234; side-right spatial group 236; rear-centre spatial group 238; a front-centre spatial group 240).

According to various examples, a change in one or more AoAs associated with one or more loudspeakers from the plurality of loudspeakers may be detected and automatically compensated by adjusting one or more parameters of sound output from the plurality of loudspeakers such that sound distribution representing sound localization becomes symmetrical with respect to a target position where a listener and/or a microphone is to be placed, wherein the one or more parameters comprise any one of sound amplitude, delay time, frequency spectrum and/or phase. The one or more parameters may be simultaneously controlled for each loudspeaker of one or more type groups (e.g., mid-range loudspeaker 214 type group; woofer loudspeaker 216 type group and tweeter loudspeaker 218 type group) and/or one or more spatial groups (e.g., front spatial group 224; side spatial group 226; rear spatial group 228; front-left spatial group 230; front-right spatial group 232: a side-left spatial group 234; side-right spatial group 236; rear-centre spatial group 238; a front-centre spatial group 240).

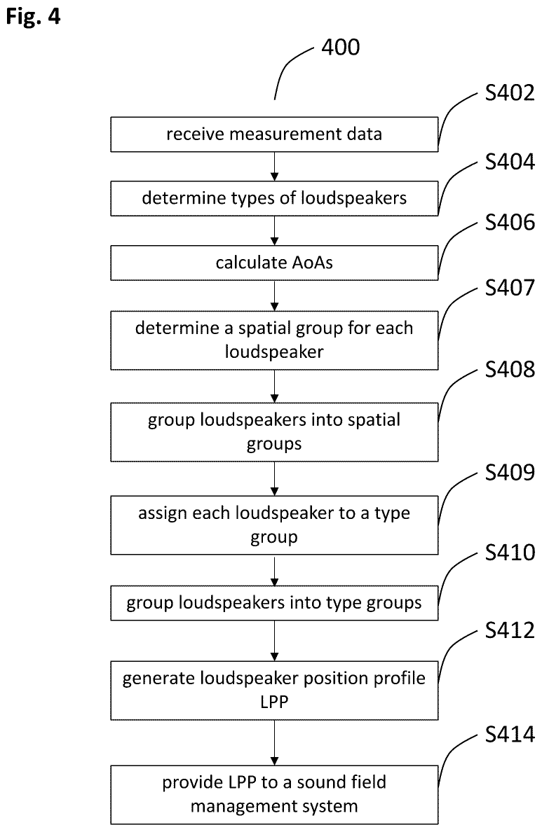

FIG. 3 schematically shows identification of angles of arrival 300 according to one of a number of embodiments.

In FIG. 3, a mid-range type loudspeaker 314 (located on a right side); a mid-range loudspeaker 314L (located on a left side); a woofer loudspeaker 316 and a tweeter loudspeaker 318 are schematically illustrated. The AoAs, Q1, Q2, Q3 and Q2L, may be calculated with respect to the position of a microphone 317; a longitudinal axis 320; and a transverse axis 322.

Q1 may refer to an angle of arrival, AoA for tweeter loudspeaker. Q2 may refer to an angle of arrival, AoA for mid-range loudspeaker (located on a right side). Q3 may refer to an angle of arrival, AoA for woofer loudspeaker. Q2L may refer to an angle of arrival, AoA for mid-range loudspeaker (located on a left side).

FIG. 4 schematically shows a method 400 of generating a loudspeaker position profile for sound management of an acoustic system according to one of a number of embodiments.

The method 400 is implemented on a computer (computer-implemented).

The acoustic system can be any multi-speaker acoustic system such as the ones described in the context of FIGS. 1 and 2 (acoustic system 102; 200a; 200b; 200c; 200d; 200e).

The method 400 comprises receiving, at step S402, measurement data of sound reproduced by each loudspeaker from the plurality of loudspeakers, wherein the sound is measured by one or more acoustic detectors placed at each target position of a plurality of target positions. The method 400 further comprises determining, at step S404, a type of each loudspeaker from the measurement data. The method 400 further comprises calculating, at step S406, from the measurement data an angle of arrival, AoA, for each loudspeaker at each target position. The method 400 further comprises determining, at step S407, a spatial group for each loudspeaker from calculated one or more AoAs at one or more target positions. The method 400 further comprises grouping, at step S408, the plurality of loudspeakers into spatial groups. The method 400 further comprises assigning, at step S409, each loudspeaker to a type group according to determined type. The method 400 further comprises grouping, at step S410, the plurality of loudspeakers into type groups. The method 400 further comprises generating, at step S412, the LPP comprising a plurality of group identifiers and a plurality of loudspeaker identifiers linking each loudspeaker from the plurality of loudspeakers to determined spatial group and to assigned type group. The method 400 further comprises providing, at step S414, the LPP via a computer interface to a sound field management system 110 for use comprising controlling one or more parameters of sound output from the acoustic system 102; 200a; 200b; 200c; 200d; 200e based on the LPP.

The method 400 can be used for an acoustic system 200c; 200d; 200e of a vehicle or an acoustic system 200a; 200b of a theatre or a conference room.

In view of the above, general conclusions can be drawn that may be summarized by the following examples.

In some examples, the computer-implemented method may further comprise determining a total number of loudspeakers in the plurality of loudspeakers from the measurement data, wherein determining the total number of loudspeakers may comprise determining a number of audio files comprised in the measurement data or determining a number of sound channels used for obtaining the measurement data.

In some examples, determining the type of each loudspeaker may comprise matching frequency spectra comprised in the measurement data to reference spectra associated with a plurality of loudspeaker types.

In some examples, determining the spatial group for each loudspeaker may comprise applying a division algorithm to the number of loudspeakers for generating a plurality of possible divisions of the plurality of loudspeakers into spatial groups. The division algorithm may incorporate adjustable criteria for determining a number of possible divisions. The adjustable criteria may comprise one or more numbers of axes of symmetry. Determining the spatial group for each loudspeaker may further comprise selecting at least one division from the plurality of possible divisions based on predefined selection criteria. The predefined selection criteria may comprise user input and/or a likelihood for each division from the plurality of possible divisions, wherein the at least one division may comprise the number of spatial groups and location information associated with each spatial group. Determining the spatial group for each loudspeaker may further comprise, automatically assigning each loudspeaker to a spatial group from the number of spatial groups based on calculated AoAs being indicative of spatial location of each loudspeaker.

In some examples, the computer-implemented method may further comprise receiving metadata for aiding loudspeakers grouping into the spatial groups and/or the type groups. The metadata may indicate a number of spatial groups wherein the number of spatial groups facilitates a selection of spatial grouping from multiple candidates of spatial grouping, location information associated with each spatial group further facilitating the selection of spatial grouping from multiple candidates of spatial grouping, and/or types of loudspeakers facilitating assignment of loudspeakers into type groups.

In some examples, the computer-implemented method may further comprise generating a searchable data structure comprising the LPP and saving the searchable data structure in an electronic database and/or a cloud for the use by the sound field management system comprising searching spatial groups and/or type groups automatically for simultaneous control of one or more parameters of loudspeakers belonging to one group.

In some examples, the controlling may comprise simultaneous control of loudspeakers belonging to the same type group and/or the same spatial group.

In some examples, the simultaneous control may comprise controlling one or more parameters of sound output comprising any one of amplitude, delay time, frequency spectrum and/or phase.

In some examples, the simultaneous control may comprise a relative control of the one or more parameters between at least two groups.

In some examples, the simultaneous control may comprise maintaining a relative relationship between the one or more parameters of the at least two groups when one or more conditions associated with the at least two groups change. The one or more conditions may comprise one or more locations of one or more loudspeakers from the plurality of loudspeakers. A change in the one or more conditions may be identified automatically by determining one or more AoAs associated with the one or more loudspeakers for a new condition and for a previous condition, and by comparing the one or more AoAs for the new condition and for the previous condition.

In some examples, the use of the LPP may further comprise generating a sound representation representing sound localization, including one or more binaural cues comprising: an interaural time difference, ITD, an interaural level difference, ILD, and/or an interaural phase difference, IPD; and, based on the sound representation, adjusting one or more parameters of sound output from the plurality of loudspeakers until the one or more binaural cues are equalized resulting in the sound representation comprising identical sound representation received by the left and right ear of a listener placed at a target position. The one or more parameters may comprise any one of sound amplitude, delay time, frequency spectrum and/or phase.

In some examples, the computer-implemented method may further comprise detecting a change in one or more AoAs associated with one or more loudspeakers from the plurality of loudspeakers and automatically compensating for the change by adjusting one or more parameters of sound output from the plurality of loudspeakers such that sound distribution representing sound localization becomes symmetrical with respect to a target position where a listener and/or a microphone is to be placed. The one or more parameters may comprise any one of sound amplitude, delay time, frequency spectrum and/or phase.

In some examples, the spatial groups may comprise a front, a side and a rear spatial groups determined along a longitudinal axis, wherein the side spatial group may be located between the front and the rear spatial group. The spatial groups may further comprise one or more height spatial groups determined along a vertical axis, wherein the vertical axis may extend across measurement space in parallel to a direction of gravity force and the longitudinal axis may extend across the measurement space perpendicular to the gravity force.

In some examples, the spatial groups may comprise a front-left, a front-right, a side-left, a side-right and a rear-centre spatial groups wherein the front and rear may be determined along a longitudinal axis and wherein the left and right may be determined along a transverse axis. The spatial groups may further comprise one or more height spatial groups determined along a vertical axis. The vertical axis may extend across measurement space in parallel to a direction of gravity force and the longitudinal and the transverse axes may be perpendicular to each other and to the vertical axis.

In some examples, the type groups may comprise any one of a tweeter, a mid-range, a woofer type group and/or a variation thereof (e.g., subwoofer, full range types, etc.) defined by a target frequency spectrum.

According to some further aspects, a computer-implemented method of generating a loudspeaker position profile for sound management of an acoustic system comprising a plurality of loudspeakers is provided. The method comprises receiving measurement data; determining types of loudspeakers; calculating angles of arrival; determining a spatial group for each loudspeaker; grouping loudspeakers into spatial groups; assigning each loudspeaker to a type group; grouping loudspeakers into type groups; generating the loudspeaker position profile; and providing the loudspeaker position profile to a sound field management system.

The description of embodiments has been presented for purposes of illustration and description. Suitable modifications and variations to the embodiments may be performed in light of the above description or may be acquired from practicing the methods. For example, unless otherwise noted, one or more of the described methods may be performed by a suitable device and/or combination of devices. The methods may be performed by executing stored instructions with one or more logic devices (e.g., processors) in combination with one or more additional hardware elements, such as storage devices, memory, hardware network interfaces/antennae, switches, actuators, clock circuits, etc. The described methods and associated actions may also be performed in various orders in addition to the order described in this application, in parallel, and/or simultaneously. The described systems are exemplary in nature, and may include additional elements and/or omit elements. The subject matter of the present disclosure includes all novel and non-obvious combinations and sub-combinations of the various systems and configurations, and other features, functions, and/or properties disclosed.

As used in this application, an element or step recited in the singular and proceeded with the word “a” or “an” should be understood as not excluding plural of said elements or steps, unless such exclusion is stated (e.g., a processor does not exclude plural of processors). Furthermore, references to “one embodiment” or “one example” of the present disclosure are not intended to be interpreted as excluding the existence of additional embodiments that also incorporate the recited features. The terms “first,” “second,” and “third,” etc. are used merely as labels, and are not intended to impose numerical requirements or a particular positional order on their objects. The following claims particularly point out subject matter from the above disclosure that is regarded as novel and non-obvious.

### REFERENCE SIGNS

100a: a computer system;
100b: data acquisition system;
102: an acoustic system;
104: metadata;
105: a searchable data structure;
106: a computer processor;
108: a loudspeaker position profile, LPP;
110: a sound field management system;
112: measurement data;
114: a measurement and assignment process;
116: selecting next speaker to be measured;
118: a measurement unit;
120: AoA calculation;
122: grouping assignment;
124: updating the LPP;
126: checking if all loudspeakers were measured;
128: end of measurement;
200a: an acoustic system of a theatre or another room;
200b: an acoustic system of a theatre or another room;
200c: an acoustic system of a vehicle;
200d: an acoustic system of a vehicle;
200e: an acoustic system of a vehicle;
202: a vehicle;
204: a vehicle front;
206: a vehicle rear;
208: a vehicle left side;
210: a vehicle left side;
212: a vehicle seats;
214: a mid-range loudspeaker;
216: a woofer loudspeaker;
218: a tweeter loudspeaker;
217: a microphone;
220: a longitudinal axis;
222: a transverse axis;
224: a front group;
226: a side group;
228: a rear group;
230: a front-left group;
232: a front-right group;
234: a side-left group;
236: a side-right group;
238: a rear-centre group;
240: a front-centre group;
242: a room or a region for an acoustic system;
300: identification of angles of arrival, AoA;
314: a mid-range type (located on a right side);
314L: a mid-range loudspeaker (located on a left side);
316: a woofer loudspeaker;
318: a tweeter loudspeaker;
317: a microphone;
320: a longitudinal axis;
322: a transverse axis;
Q1: an angle of arrival, AoA for tweeter loudspeaker;
Q2: an angle of arrival, AoA for mid-range loudspeaker (located on a right side);
Q3: an angle of arrival, AoA for woofer loudspeaker;
Q2L: an angle of arrival, AoA for mid-range loudspeaker (located on a left side);
400: a method;
S402: receive measurement data;
S404: determine a number and types of loudspeakers;
S406: calculate AoAs;
S407: determine a spatial group for each loudspeaker
S408: group loudspeakers into spatial groups;
S409: assign each loudspeaker to a type group;
S410: group loudspeakers into type groups;
S412: generate loudspeaker position profile, LPP;
S414: provide the LPP to a sound field management system.

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method of generating a loudspeaker position profile (LPP) for sound management of an acoustic system comprising a plurality of loudspeakers, the method comprising:
receiving measurement data of sound reproduced by each loudspeaker from the plurality of loudspeakers, wherein the sound is measured by one or more acoustic detectors placed at each target position of a plurality of target positions;
determining a type of each loudspeaker from the measurement data;
calculating from the measurement data an angle of arrival (AoA) for each loudspeaker at each target position;
determining a spatial group for each loudspeaker from the calculated AoAs at one or more target positions,
grouping the plurality of loudspeakers into spatial groups;
generating the LPP comprising a plurality of group identifiers and a plurality of loudspeaker identifiers linking each loudspeaker from the plurality of loudspeakers to the determined spatial group and to the assigned type group; and
provide the LPP via a computer interface to a sound field management system for use comprising controlling one or more parameters of sound output from the acoustic system based on the LPP.

2. The computer-implemented method of claim 1, further comprising determining a total number of loudspeakers in the plurality of loudspeakers from the measurement data, wherein determining the total number of loudspeakers comprises determining a number of audio files comprised in the measurement data or determining a number of sound channels used for obtaining the measurement data.

3. The computer-implemented method of claim 1, wherein determining the type of each loudspeaker comprises matching frequency spectra comprised in the measurement data to reference spectra associated with a plurality of loudspeaker types.

4. The computer-implemented method of claim 1, wherein determining the spatial group for each loudspeaker comprises:
applying a division algorithm to a number of loudspeakers for generating a plurality of possible divisions of the plurality of loudspeakers into spatial groups, wherein the division algorithm incorporates adjustable criteria for determining a number of possible divisions, wherein the adjustable criteria comprise one or more numbers of axes of symmetry,
selecting at least one division from the plurality of possible divisions based on predefined selection criteria, wherein the predefined selection criteria comprise at least one of user input or a likelihood for each division from the plurality of possible divisions, wherein the at least one division comprises the number of spatial groups and location information associated with each spatial group; and
based on the calculated AoAs being indicative of spatial location of each loudspeaker, automatically assigning each loudspeaker to a spatial group from the number of spatial groups.

5. The computer-implemented method of claim 1, wherein the method further comprises receiving metadata for aiding loudspeaker grouping into the spatial groups or the type groups, the metadata indicating: a number of spatial groups wherein the number of spatial groups facilitates a selection of a spatial grouping from multiple candidates of spatial grouping, location information associated with each spatial group further facilitating the selection of the spatial grouping from multiple candidates of spatial grouping, or types of the loudspeakers facilitating assignment of loudspeakers into type groups.

6. The computer-implemented method of claim 1, wherein the method further comprises generating a searchable data structure comprising the LPP and saving the searchable data structure in an electronic database or a cloud for use by the sound field management system comprising searching spatial groups or type groups automatically for simultaneous control of one or more parameters of loudspeakers belonging to one group.

7. The computer-implemented method of claim 1, wherein the controlling comprises simultaneous control of loudspeakers belonging to a same type group or a same spatial group.

8. The computer-implemented method of claim 7, wherein the simultaneous control comprises controlling one or more parameters of sound output comprising any one of amplitude, delay time, frequency spectrum or phase, and wherein the simultaneous control comprises:
a relative control of the one or more parameters between at least two groups; or
maintaining a relative relationship between the one or more parameters of the at least two groups when one or more conditions associated with the at least two groups change,
wherein the one or more conditions comprise one or more locations of one or more loudspeakers from the plurality of loudspeakers, and
wherein a change in the one or more conditions is identified automatically by determining one or more AoAs associated with the one or more loudspeakers for a new condition and for a previous condition, and by comparing the one or more AoAs for the new condition and for the previous condition.

9. The computer-implemented method of claim 1, wherein the use further comprises:
generating a sound representation representing sound localization, including one or more binaural cues comprising: an interaural time difference (ITD) an interaural level difference (ILD) or an interaural phase difference (IPD); and
based on the sound representation, adjusting one or more parameters of sound output from the plurality of loudspeakers until the one or more binaural cues are equalized resulting in the sound representation comprising identical sound representation received by a left ear and a right ear of a listener located at a target position, wherein the one or more parameters comprise one or more of sound amplitude, delay time, frequency spectrum, or phase.

10. The computer-implemented method of claim 1, the method further comprising detecting a change in one or more AoAs associated with one or more loudspeakers from the plurality of loudspeakers and automatically compensating for the change by adjusting one or more parameters of sound output from the plurality of loudspeakers such that sound distribution representing sound localization becomes symmetrical with respect to a target position where a listener and/or a microphone is located, wherein the one or more parameters comprise one or more of sound amplitude, delay time, frequency spectrum, and/or phase.

11. The computer-implemented method of claim 1, wherein the spatial groups comprise a front, a side special group and a rear spatial group determined along a longitudinal axis, wherein the side spatial group is located between the front and the rear spatial group, and optionally, wherein the spatial groups comprise one or more height groups determined along a vertical axis, wherein the vertical axis extends across measurement space in parallel to a direction of gravity force and the longitudinal axis extends across the measurement space perpendicular to the gravity force.

12. The computer-implemented method of claim 1:
wherein the spatial groups comprise a front-left, a front-right, a side-left, a side-right and a rear-centre spatial groups wherein front and rear are determined along a longitudinal axis and wherein left and right are determined along a transverse axis,
wherein the vertical axis extends across measurement space in parallel to a direction of gravity force and a longitudinal and a transverse axes are perpendicular to each other and to the vertical axis.

13. The computer-implemented method of claim 1, wherein the type groups comprise one or more of a tweeter, a mid-range, a woofer type group or a variation thereof defined by a target frequency spectrum.

14. An acoustic system comprising:
a plurality of loudspeakers;
a memory storing an application; and
a processor coupled to the memory that executes the application by performing the steps of:
receiving measurement data of sound reproduced by each loudspeaker from the plurality of loudspeakers, wherein the sound is measured by one or more acoustic detectors placed at each target position of a plurality of target positions;
determining a type of each loudspeaker from the measurement data;
calculating from the measurement data an angle of arrival (AoA) for each loudspeaker at each target position;
determining a spatial group for each loudspeaker from the calculated AoAs at one or more target positions,
grouping the plurality of loudspeakers into spatial groups;
assigning each loudspeaker to a type group according to determined type,
grouping the plurality of loudspeakers into type groups;
generating a loudspeaker position profile (LPP) comprising a plurality of group identifiers and a plurality of loudspeaker identifiers linking each loudspeaker from the plurality of loudspeakers to the determined spatial group and to the assigned type group; and
provide the LPP via a computer interface to a sound field management system for use comprising controlling one or more parameters of sound output from the acoustic system based on the LPP.

15. The acoustic system of claim 14, further comprising determining a total number of loudspeakers in the plurality of loudspeakers from the measurement data, wherein determining the total number of loudspeakers comprises determining a number of audio files comprised in the measurement data or determining a number of sound channels used for obtaining the measurement data.

16. The acoustic system of claim 14, wherein determining the type of each loudspeaker comprises matching frequency spectra comprised in the measurement data to reference spectra associated with a plurality of loudspeaker types.

17. The acoustic system of claim 14, wherein determining the spatial group for each loudspeaker comprises:
applying a division algorithm to a number of loudspeakers for generating a plurality of possible divisions of the plurality of loudspeakers into spatial groups, wherein the division algorithm incorporates adjustable criteria for determining a number of possible divisions, wherein the adjustable criteria comprise one or more numbers of axes of symmetry,
selecting at least one division from the plurality of possible divisions based on predefined selection criteria, wherein the predefined selection criteria comprise at least one of user input or a likelihood for each division from the plurality of possible divisions, wherein the at least one division comprises the number of spatial groups and location information associated with each spatial group; and
based on the calculated AoAs being indicative of spatial location of each loudspeaker, automatically assigning each loudspeaker to a spatial group from the number of spatial groups.

18. The acoustic system of claim 14, further comprising receiving metadata for aiding loudspeakers grouping into the spatial groups or the type groups, the metadata indicating: a number of spatial groups wherein the number of spatial groups facilitates a selection of a spatial grouping from multiple candidates of spatial grouping, location information associated with each spatial group further facilitating the selection of the spatial grouping from multiple candidates of spatial grouping, or types of loudspeakers facilitating assignment of the loudspeakers into type groups.

19. The acoustic system of claim 14, further comprising generating a searchable data structure comprising the LPP and saving the searchable data structure in an electronic database or a cloud for the use by the sound field management system comprising searching spatial groups or type groups automatically for simultaneous control of one or more parameters of loudspeakers belonging to one group.

20. One or more non-transitory computer-readable media storing instructions that, when executed by one or more processors, cause the one or more processors to perform the steps of:
receiving measurement data of sound reproduced by each loudspeaker from a plurality of loudspeakers, wherein the sound is measured by one or more acoustic detectors placed at each target position of a plurality of target positions;
determining a type of each loudspeaker from the measurement data;
calculating from the measurement data an angle of arrival (AoA) for each loudspeaker at each target position;
determining a spatial group for each loudspeaker from the calculated AoAs at one or more target positions,
grouping the plurality of loudspeakers into spatial groups;
assigning each loudspeaker to a type group according to determined type,
grouping the plurality of loudspeakers into type groups;
generating a loudspeaker position profile (LPP) comprising a plurality of group identifiers and a plurality of loudspeaker identifiers linking each loudspeaker from the plurality of loudspeakers to determined spatial group and to assigned type group; and
provide the LPP via a computer interface to a sound field management system for use comprising controlling one or more parameters of sound output from the acoustic system based on the LPP.
